(19) United States
(12) Patent Application Publication
(10) Pub. No.: US 2014/0060492 A1
(43) Pub. Date: Mar. 6, 2014

(54) METHOD FOR MODIFYING A VEHICLE TO RECEIVE AND UTILIZE A SECONDARY FUEL

(71) Applicants: WALTER ALBERT WOOLVETT, BRACEBRIDGE (CA); PETER BENEDICT, TORONTO (CA)

(72) Inventors: WALTER ALBERT WOOLVETT, BRACEBRIDGE (CA); PETER BENEDICT, TORONTO (CA)

(21) Appl. No.: 13/963,318

(22) Filed: Aug. 9, 2013

Related U.S. Application Data
(60) Provisional application No. 61/693,855, filed on Aug. 28, 2012.

(51) Int. Cl. F02D 19/06

(52) U.S. Cl. CPC F02D 19/06
USPC 123/478

(57) ABSTRACT

A method for modifying a vehicle to receive and utilize a secondary fuel is provided, as well as the modified vehicle. The vehicle prior to modification can use a primary fuel, and comprises signal transmitter for supplying a signal having a pulse width that varies to vary the quantity of primary fuel provided. The method involves installing a secondary fuel supply module for supplying to the engine a secondary fuel different from the primary fuel, the secondary fuel supply module comprising a secondary fuel injector. The secondary fuel supply module is configured such that the signal transmitter transmits the signal having the pulse width with the duration to the secondary fuel injector to control the secondary fuel injector to provide a suitable quantity of fuel to the engine.

This application is a non-provisional application of U.S. Provisional Patent Application No. 61/693,855, filed Aug. 28, 2012, the content of which is incorporated herein by reference in its entirety.

### FIELD

The present invention relates to methods for modifying a conventionally fueled vehicle to receive and utilize a secondary fuel.

### BACKGROUND

There exist few conventionally fueled gasoline powered vehicles converted to utilize a secondary fuel such as, for example, propane or natural gas using electronically controlled fuel injectors. The vehicles that are converted generally have their OEM fuel injectors replaced with a series of electronically controlled secondary fuel injectors that are installed in the manifold block or injector rail of the vehicle.

To ensure supply of an appropriate amount of the secondary fuel to the engine, the vehicle's engine control unit (ECU) is generally reprogrammed to ensure control signals provided to the installed secondary fuel injectors are of an appropriate pulse width for the type of secondary fuel being supplied to the engine. Other systems, such as that disclosed in U.S. Pat. No. 5,092,305, require a user to install a secondary ECU configured to receive and modify control signals generated by the vehicle's existing ECU before the signals are received by the installed secondary fuel injectors.

### SUMMARY

Requiring a user to replace existing fuel injectors, or to reprogram or install an ECU can make current methods of modifying a conventionally fueled vehicle to utilize a secondary fuel complicated and expensive. Such problems can be solved by modifying a conventionally fueled vehicle to utilize a secondary fuel such as, for example, propane or natural gas by installing a secondary fuel supply system in the vehicle without significantly altering the vehicle's existing fuel supply system, and by using—without modifying—the control signals sent by the vehicle's existing ECU to control the amount of secondary fuel supplied to the engine by the installed secondary fuel supply system. The installed secondary fuel supply system can be configured to ensure a suitable amount of secondary fuel is supplied to the engine.

An advantage of the present invention is simplicity and cost-effectiveness in modifying a conventionally fueled vehicle to utilize a secondary fuel. An advantage of utilizing a secondary fuel such as, for example, propane or natural gas can be the reduction of air pollution and greenhouse gases associated with burning conventional fuels such as gasoline. Costs related to fueling the vehicle can also be reduced, as secondary fuels may be cheaper to purchase than gasoline. A further advantage of the present invention may be that the method does not interfere with the engine's original sensors or emission control devices, ensuring a lack of redundancy among the vehicle's components.

In accordance with an aspect of an embodiment of the invention there is provided a method for modifying a vehicle to receive and utilize a secondary fuel. The vehicle prior to modification comprises i) an internal combustion engine configured to receive and utilize a primary fuel; ii) a primary fuel supply module for supplying the primary fuel to the engine, the primary fuel supply module comprising a primary fuel injector having a primary fuel supply mode for supplying the primary fuel to the engine, and a primary fuel inactivated mode for interrupting supply of the primary fuel to the engine; iii) a plurality of sensors for providing sensor signals for determining engine parameters representing an engine fuel demand, the plurality of sensors being configured to change the sensor signals provided in response to changes in the engine parameters; and iv) a control module configured to receive the sensor signals and generate, based on the sensor signals, a signal having a pulse width with a duration. The control module is further operable to change the duration of the pulse width based on changes in the sensor signals. The control module has a signal transmitter configured for transmitting the signal to the primary fuel injector to maintain the primary fuel injector in the primary fuel supply mode when receiving the signal for the duration of the pulse width to supply an amount of primary fuel to the engine sufficient to satisfy the engine fuel demand. The primary fuel injector is configured to return to the primary fuel inactivated mode when not receiving the signal.

The method for modifying the vehicle to receive and utilize the secondary fuel comprises installing in the vehicle a secondary fuel supply module for supplying to the engine a secondary fuel different from the primary fuel. The secondary fuel supply module comprises a secondary fuel injector having a secondary fuel supply mode for supplying the secondary fuel to the engine, and a secondary fuel inactivated mode for interrupting supply of the secondary fuel to the engine. The secondary fuel supply module is configurable to adjust a secondary fuel supply rate at which the secondary fuel is supplied to the engine. The engine fuel demand corresponds to an amount of the secondary fuel to be supplied to the engine to satisfy the engine fuel demand. The amount of the secondary fuel to be supplied to the engine to satisfy the engine fuel demand is different from the amount of the primary fuel to be supplied to the engine to satisfy the engine fuel demand. The method further comprises connecting the signal transmitter to the secondary fuel injector such that the signal transmitter is configured to transmit the signal having the pulse width with the duration to the secondary fuel injector to maintain the secondary fuel injector in the secondary fuel supply mode when receiving the signal for the duration of the pulse width. The secondary fuel injector is configured to return to the secondary fuel inactivated mode when not receiving the signal. The method further comprises installing the secondary fuel supply module at a selected adjustment setting to provide a selected secondary fuel supply rate such that when the signal is received by the secondary fuel injector for the duration of the pulse width, the secondary fuel injector is maintained in the secondary fuel supply mode to supply to the engine the amount of the secondary fuel to be supplied to the engine to satisfy the engine fuel demand. When the secondary fuel is being supplied at the selected secondary fuel supply rate the secondary fuel injector is configured to change the amount of the secondary fuel provided to the engine in response to changes in the duration of the pulse width of the signal received.

In accordance with a further aspect of an embodiment of the invention, the method for modifying the vehicle to receive and utilize a secondary fuel further comprises installing the secondary fuel supply module at an initial adjustment setting to provide an initial secondary fuel supply rate such that when the signal is received by the secondary fuel injector for the duration of the pulse width, the secondary fuel injector is maintained in the secondary fuel supply mode to provide to the engine an initial amount of the secondary fuel. The method further comprises determining if the initial amount of the secondary fuel is the amount of the secondary fuel to be supplied to the engine to satisfy the engine fuel demand. If the initial amount of the secondary fuel is the amount of the secondary fuel to be supplied to the engine to satisfy the engine fuel demand, then the secondary fuel supply module is left at the initial adjustment setting; otherwise the secondary fuel supply module is adjusted to the selected adjustment setting to provide the selected secondary fuel supply rate.

In accordance with a further aspect of an embodiment of the invention, the primary fuel is gasoline.

In accordance with a further aspect of an embodiment of the invention, the secondary fuel is one of propane and natural gas.

In accordance with a further aspect of an embodiment of the invention, the vehicle prior to modification further comprises an air intake module for supplying air at an air pressure to the engine. The air pressure is at or above barometric pressure. The secondary fuel supply module is configured to supply at a supply pressure the secondary fuel to the secondary fuel injector and to store the secondary fuel at a variable storage pressure. The variable storage pressure is at or above the supply pressure. The supply pressure is above the air pressure. The secondary fuel supply module further comprises an adjustable pressure regulator configurable to adjust the supply pressure. Installing the secondary fuel supply module at the selected adjustment setting comprises adjusting the adjustable pressure regulator such that the adjustable pressure regulator provides the secondary fuel at the selected secondary fuel supply rate and at the supply pressure when the secondary fuel injector is supplying the secondary fuel to the engine.

In accordance with a further aspect of an embodiment of the invention, when the secondary fuel injector is in the secondary fuel supply mode, the secondary fuel injector is configured to supply to the engine the secondary fuel through an aperture. The secondary fuel injector comprises an adjustable aperture device for adjusting an area of the aperture.

In accordance with a further aspect of an embodiment of the invention, the method for modifying the vehicle to receive and utilize the secondary fuel further comprises installing a fuel supply mode selection component for selecting for the vehicle either a primary fuel mode or a secondary fuel mode. When the primary fuel mode is selected, the primary fuel supply module is configured to supply the primary fuel to the primary fuel injector and the secondary fuel supply module is configured to interrupt supply of the secondary fuel to the secondary fuel injector. When the secondary fuel mode is selected, the secondary fuel supply module is configured to supply the secondary fuel to the secondary fuel injector and the primary fuel supply module is configured to interrupt supply of the primary fuel to the primary fuel injector.

In accordance with a further aspect of an embodiment of the invention, the vehicle prior to modification further comprises an air intake module for supplying air to the engine. The air intake module comprises a throttle body component having an air supply control valve for controlling the supply of air to the engine and for separating the air intake module into an upstream portion and a downstream portion. The air intake module is configured such that when the air intake module is supplying the air to the engine, the air flows through the upstream portion of the air intake module, through the air supply control valve, and through the downstream portion of the air intake module, respectively, before being supplied to the engine. The secondary fuel injector is installed in the vehicle such that when the secondary fuel injector supplies the secondary fuel from the secondary fuel supply module and the air intake module is supplying air to the engine, the secondary fuel injector supplies the secondary fuel from the secondary fuel supply module into the upstream portion of the air intake module such that the supplied secondary fuel mixes with the air flowing through the air intake module forming a secondary fuel and air mixture to be supplied to the engine.

In accordance with a further aspect of an embodiment of the invention, the secondary fuel injector is installed within 3 inches of the air supply control valve.

In accordance with a further aspect of an embodiment of the invention, the secondary fuel supply module comprises a secondary fuel storage component. The secondary fuel storage component is configured to store at a variable storage pressure a stored amount of the secondary fuel. The secondary fuel supply module further comprises a heating component for transferring heat energy from the heating component to the stored amount of the secondary fuel to raise the variable storage pressure to a suitable storage pressure.

In accordance with a further aspect of an embodiment of the invention, the secondary fuel supply module comprises a safety component. The safety component has a secondary fuel safe mode for supplying the secondary fuel to the secondary fuel injector, and a secondary fuel failsafe mode for interrupting supply of the secondary fuel to the secondary fuel injector. The vehicle prior to modification further comprises at least one safety sensor for providing a safety signal representing vehicle safety parameters corresponding to at least one of the vehicle being in operation, the vehicle being in an accident, and the vehicle malfunctioning. The control module is further configured to receive the at least one safety signal and generate, based on the at least one safety signal, a derivative safety signal representing whether the vehicle satisfies the vehicle safety parameters. The control module also has a safety signal transmitter configured for transmitting the derivative safety signal. The method for modifying the vehicle to receive and utilize the secondary fuel further comprises connecting the safety signal transmitter to the safety component such that the safety signal transmitter is configured to transmit the derivative safety signal to the safety component to maintain the safety component in the secondary fuel safe mode when receiving the derivative safety signal. The safety component is configured to return to the secondary fuel failsafe mode when not receiving the derivative safety signal.

In accordance with a further aspect of an embodiment of the invention, the method for modifying the vehicle to receive and utilize the secondary fuel is carried out during manufacture of the vehicle.

In accordance with a further aspect of an embodiment of the invention, the engine parameters comprise position of an air intake throttle, temperature of air supplied to the engine, temperature of engine coolant, rotational speed of the engine, barometric pressure, and at least one of pressure in an intake manifold of the engine and mass flow rate of air supplied to the engine.

In accordance with a further aspect of an embodiment of the invention, the engine parameters further comprise oxygen concentration of engine exhaust gases.

In accordance with a further aspect of an embodiment of the invention, there is provided a vehicle modified to receive and utilize a secondary fuel. The vehicle comprises i) an internal combustion engine configured to receive and utilize a primary fuel; ii) a primary fuel supply module for supplying the primary fuel to the engine, the primary fuel supply module comprising a primary fuel injector having a primary fuel supply mode for supplying the primary fuel to the engine, and a primary fuel inactivated mode for interrupting supply of the primary fuel to the engine; iii) a plurality of sensors for providing sensor signals for determining engine parameters representing an engine fuel demand, the plurality of sensors being configured to change the sensor signals provided in response to changes in the engine parameters; iv) a control module configured to receive the sensor signals and generate, based on the sensor signals, a signal having a pulse width with a duration, the control module being further operable to change the duration of the pulse width based on changes in the sensor signals, the control module having a signal transmitter configured for transmitting the signal to the primary fuel injector to maintain the primary fuel injector in the primary fuel supply mode when receiving the signal for the duration of the pulse width to supply an amount of primary fuel to the engine sufficient to satisfy the engine fuel demand, the primary fuel injector being configured to return to the primary fuel inactivated mode when not receiving the signal; and v) a secondary fuel supply module for supplying to the engine a secondary fuel different from the primary fuel. The secondary fuel supply module comprises a secondary fuel injector having a secondary fuel supply mode for supplying the secondary fuel to the engine, and a secondary fuel inactivated mode for interrupting supply of the secondary fuel to the engine. The secondary fuel supply module is configurable to adjust a secondary fuel supply rate at which the secondary fuel is supplied to the engine. The engine fuel demand corresponds to an amount of the secondary fuel to be supplied to the engine to satisfy the engine fuel demand. The amount of the secondary fuel to be supplied to the engine to satisfy the engine fuel demand is different from the amount of the primary fuel to be supplied to the engine to satisfy the engine fuel demand. Further, the signal transmitter is connected to the secondary fuel injector such that the signal transmitter is configured to transmit the signal having the pulse width with the duration to the secondary fuel injector to maintain the secondary fuel injector in the secondary fuel supply mode when receiving the signal for the duration of the pulse width. The secondary fuel injector is configured to return to the secondary fuel inactivated mode when not receiving the signal. The secondary fuel supply module is at a selected adjustment setting to provide a selected secondary fuel supply rate such that when the signal is received by the secondary fuel injector for the duration of the pulse width, the secondary fuel injector is maintained in the secondary fuel supply mode to supply to the engine the amount of the secondary fuel to be supplied to the engine to satisfy the engine fuel demand. When the secondary fuel is being supplied at the selected secondary fuel supply rate the secondary fuel injector is configured to change the amount of the secondary fuel provided to the engine in response to changes in the duration of the pulse width of the signal received.

In accordance with a further aspect of an embodiment of the invention, the vehicle further comprises an air intake module for supplying air at an air pressure to the engine. The air pressure being at or above barometric pressure. The secondary fuel supply module is configured to supply at a supply pressure the secondary fuel to the secondary fuel injector and to store the secondary fuel at a variable storage pressure. The variable storage pressure is at or above the supply pressure. The supply pressure is above the air pressure. The secondary fuel supply module further comprises an adjustable pressure regulator configurable to adjust the supply pressure. The pressure regulator is configured to provide the secondary fuel at the selected secondary fuel supply rate and at the supply pressure when the secondary fuel injector is supplying the secondary fuel to the engine.

In accordance with a further aspect of an embodiment of the invention, when the vehicle is in the secondary fuel supply mode, the secondary fuel injector is configured to supply to the engine the secondary fuel through an aperture. The secondary fuel injector comprises an adjustable aperture device for adjusting an area of the aperture.

In accordance with a further aspect of an embodiment of the invention, the vehicle further comprises a fuel supply mode selection component for selecting for the vehicle either a primary fuel mode or a secondary fuel mode. When the primary fuel mode is selected, the primary fuel supply module is configured to supply the primary fuel to the primary fuel injector and the secondary fuel supply module is configured to interrupt supply of the secondary fuel to the secondary fuel injector. When the secondary fuel mode is selected, the secondary fuel supply module is configured to supply the secondary fuel to the secondary fuel injector and the primary fuel supply module is configured to interrupt supply of the primary fuel to the primary fuel injector.

In accordance with a further aspect of an embodiment of the invention, the vehicle further comprises an air intake module for supplying air to the engine. The air intake module comprises a throttle body component having an air supply control valve for controlling the supply of air to the engine and for separating the air intake module into an upstream portion and a downstream portion. The air intake module is configured such that when the air intake module is supplying the air to the engine, the air flows through the upstream portion of the air intake module, through the air supply control valve, and through the downstream portion of the air intake module, respectively, before being supplied to the engine. The secondary fuel injector is configured such that when the secondary fuel injector supplies the secondary fuel from the secondary fuel supply module and the air intake module is supplying air to the engine, the secondary fuel injector supplies the secondary fuel from the secondary fuel supply module into the upstream portion of the air intake module such that the supplied secondary fuel mixes with the air flowing through the air intake module forming a secondary fuel and air mixture to be supplied to the engine.

In accordance with a further aspect of an embodiment of the invention, the secondary fuel injector is configured to supply the secondary fuel within 3 inches of the air supply control valve.

In accordance with a further aspect of an embodiment of the invention, the secondary fuel supply module comprises a safety component. The safety component has a secondary fuel safe mode for supplying the secondary fuel to the secondary fuel injector, and a secondary fuel failsafe mode for interrupting supply of the secondary fuel to the secondary fuel injector. The vehicle further comprises at least one safety sensor for providing a safety signal representing vehicle safety parameters corresponding to at least one of the vehicle being in operation, the vehicle being in an accident, and the vehicle malfunctioning. The control module is further configured to receive the at least one safety signal and generate, based on the at least one safety signal, a derivative safety signal representing whether the vehicle satisfies the vehicle safety parameters. The control module has a safety signal transmitter configured for transmitting the derivative safety signal. The safety signal transmitter is configured to transmit the derivative safety signal to the safety component to maintain the safety component in the secondary fuel safe mode when receiving the derivative safety signal. The safety component is configured to return to the secondary fuel failsafe mode when not receiving the derivative safety signal.

### DRAWINGS

The person skilled in the art will understand that the drawings, described below, are for illustration purposes only. The drawings are not intended to limit the scope of the applicants' teachings in any way:

FIG. 1, in a side view, illustrates a portion of a vehicle's fuel supply system prior to modification;

FIG. 2, in a side view, illustrates the vehicle of FIG. 1 after being modified according to one embodiment of the present invention;

FIG. 3, in a schematic view, illustrates several components of the electronic fuel control system of the modified vehicle illustrated in FIG. 2;

FIG. 4, in a schematic sectional view, illustrates one embodiment of the internal combustion engine and air intake module of the modified vehicle illustrated in FIG. 2;

FIG. 5, in a schematic view, illustrates one embodiment of two fuel supply modules and a fuel supply mode selection component of the modified vehicle illustrated in FIG. 2; and

FIG. 6, in a top view, illustrates one embodiment of a heating component of the modified vehicle illustrated in FIG. 2.

### DESCRIPTION OF VARIOUS EMBODIMENTS

Multiple embodiments of the invention are described below. For clarity, the same reference numbers are used to designate elements of the different embodiments that are analogous to one another. For brevity, the description of previously discussed figures is not repeated.

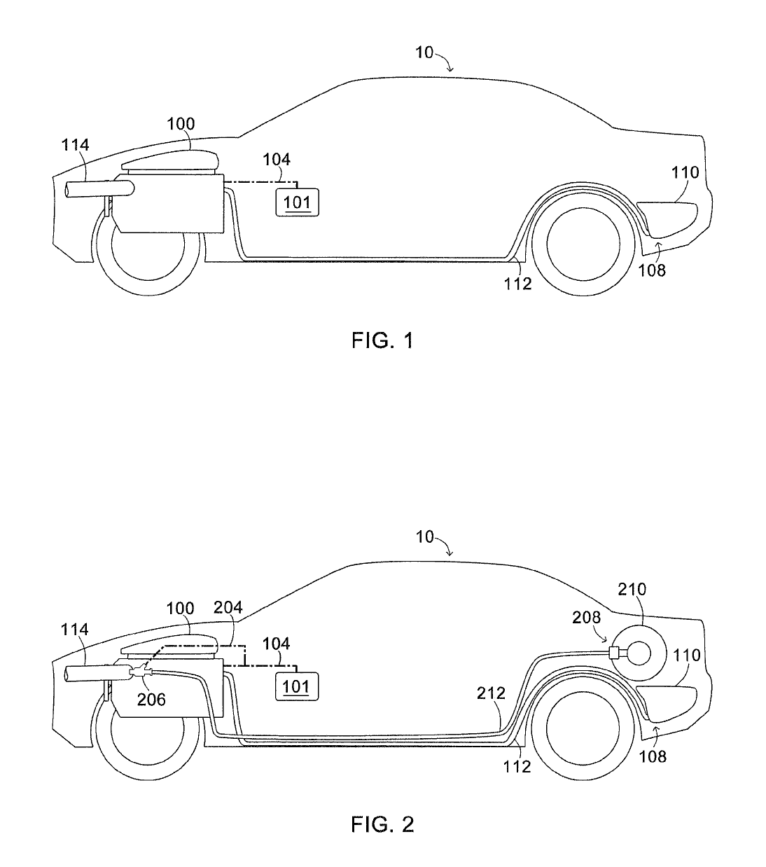

Referring to FIG. 1, there is illustrated a side view of a conventional vehicle indicated at 10 having internal combustion engine 100 configured to receive and utilize a primary fuel, air intake module 114 connected to engine 100, electronic fuel control system 101, signal transmitter 104, and primary fuel supply module 108.

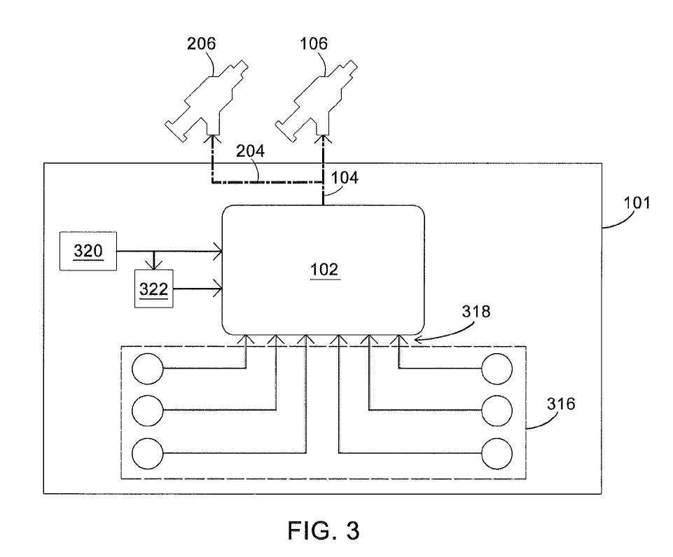

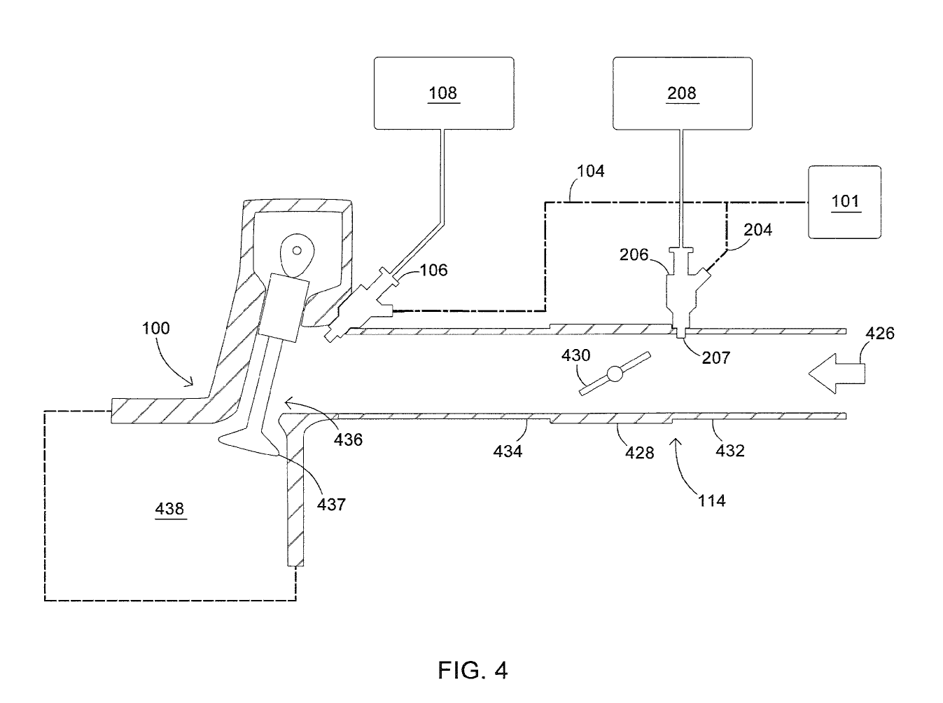

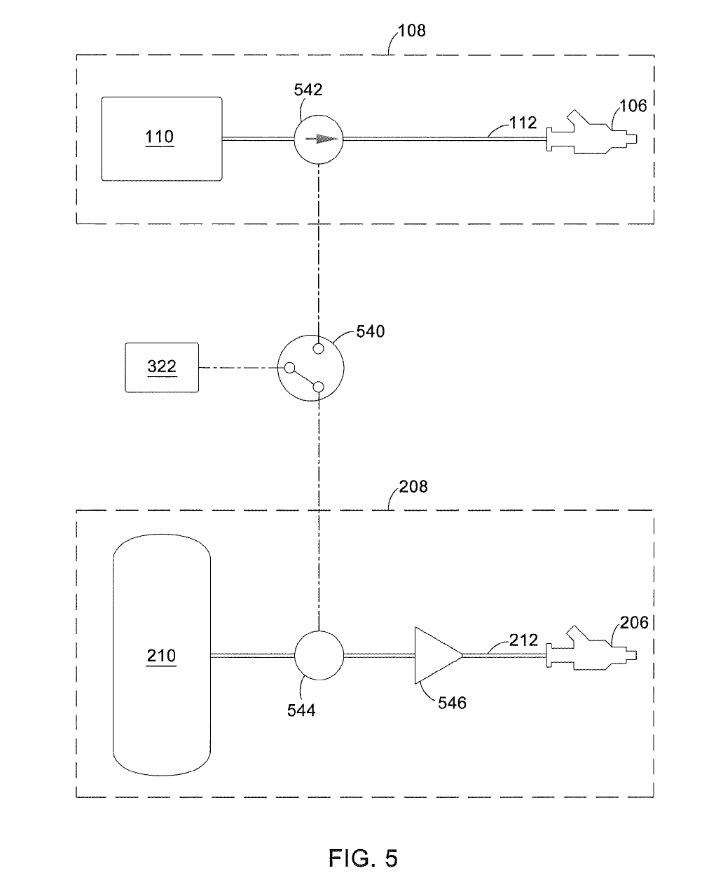

Primary fuel supply module 108 can comprise primary fuel injector 106 (shown in FIG. 3, FIG. 4, and FIG. 5), primary fuel storage component 110, electric primary fuel pump 542 (FIG. 5), and primary fuel supply line 112. Primary fuel storage component 110 can be a storage tank configured to store a conventional primary fuel that can power engine 100 such as, for example, gasoline. Primary fuel pump 542 can supply the primary fuel from primary fuel storage component 110 to engine 100 through primary fuel supply line 112. When supplied to engine 100, the primary fuel can be received by at least one primary fuel injector 106, which can be configured to meter the amount of primary fuel being supplied to engine 100. For brevity, the description and drawings refer to a single primary fuel injector 106; however, it will be understood that primary fuel injector 106 can represent a plurality of primary fuel injectors 106, the number of primary fuel injectors 106 depending on the type of fuel injection system utilized by engine 100. For example, in sequential port injection engines, the number of primary fuel injectors 106 may be equal to the number of combustion chambers in the engine.

Primary fuel injector 106 may be, for example, a solenoid type fuel injector. A solenoid type fuel injector can be configured to receive an electrical control signal such as, for example, a 12 volt signal. In response to receiving a control signal, a solenoid type fuel injector can become activated. When activated, a solenoid type fuel injector may provide an aperture through which any received fuel can be supplied. When not receiving a control signal, a solenoid type fuel injector can be inactivated. When inactivated, a solenoid type fuel injector may not provide any aperture through which received fuel can be supplied, thus interrupting the supply of any received fuel.

Primary fuel injector 106 may receive electrical control signals such as, for example, 12 volt signals from fuel control system 101 via signal transmitter 104. In response to receiving the control signals, primary fuel injector 106 can become activated. When activated, primary fuel injector 106 can enter a primary fuel supply mode in which primary fuel injector 106 may provide an aperture through which received primary fuel can be supplied to engine 100. The supplied primary fuel can mix with air supplied at or above barometric pressure by air intake module 114 to form an air-fuel mixture used for combustion in the combustion chambers of engine 100. When not receiving a control signal via signal transmitter 104, primary fuel injector 106 may be inactivated. When inactivated, primary fuel injector 106 may enter a primary fuel inactivated mode in which primary fuel injector 106 may not provide any aperture through which received primary fuel can be supplied, thus interrupting supply to engine 100 of any received primary fuel.

Referring to FIG. 3, there is shown a schematic view of fuel control system 101. Fuel control system 101 may comprise control module 102, signal transmitter 104, a plurality of sensors 316 linked to control module 102 for communication therewith, a plurality of sensor signals 318 corresponding to plurality of sensors 316, battery 320, and ignition switch 322.

Battery 320 can provide the electrical power required to start engine 100. Ignition switch 322 can be used to start and stop engine 100. Control module 102 may utilize received information to control the operation of engine 100; namely, by timing the firing of spark plugs, and by timing the control signals provided to primary fuel injector 106 to meter the amount of fuel supplied by primary fuel injector 106 to engine 100.

To control operation of engine 100, control module 102 may contain a microcontroller that receives information from the plurality of sensors 316 via sensor signals 318. Plurality of sensors 316 may be configured to sense user input and operating conditions of vehicle 10, and to transmit to control module 102 sensor signals 318 that may correspond to the sensed user input and operating conditions of vehicle 10.

Control module 102 may use the information provided by sensor signals 318 to determine engine parameters representing a fuel demand of engine 100. The fuel demand of engine 100 can correspond to an amount of primary fuel to be supplied to engine 100 that can satisfy desired performance requirements of engine 100 such as, for example, efficiency of engine 100, exhaust emissions of engine 100, health of engine 100, power output of engine 100, and torque output of engine 100. The performance requirements may correspond to specific air to primary fuel ratios of a mixture of air and the amount of primary fuel to be supplied to engine 100.

Accordingly, plurality of sensors 316 may comprise any sensors that can provide sensor signals comprising information relevant to determining the fuel demand of engine 100. In one embodiment, plurality of sensors 316 may comprise a throttle position sensor (TPS), manifold air temperature sensor (MAT), engine coolant temperature sensor (ECT), crankshaft and engine rotational speed sensor, barometric pressure sensor, and mass air flow sensor (MAF). In a further embodiment, plurality of sensors 316 may further comprise a manifold absolute pressure sensor (MAP) in addition to, or instead of, a mass air flow sensor (MAF). In yet a further embodiment, plurality of sensors 316 may further comprise an exhaust gas oxygen sensor (O₂).

Sensor signals 318 provided to control module 102 may vary based on changes in user input or operating conditions of vehicle 10. In response to a change in sensor signals 318, control module 102 may re-determine engine parameters and the corresponding fuel demand of engine 100.

Upon determining the fuel demand of engine 100, control module 102 can be configured to generate electrical control signals having pulse widths of varying durations and transmit the generated control signals to primary fuel injector 106 via signal transmitter 104. The duration of the pulse width can correspond to an amount of time primary fuel injector 106 can be activated to supply to engine 100 an amount of primary fuel sufficient to satisfy the fuel demand of engine 100. The duration of the pulse width of the control signals generated by control module 102 may vary based on the determined fuel demand of engine 100.

In response to receiving a generated control signal, primary fuel injector 106 may become activated for the duration of the pulse width corresponding to the received control signal, supplying an amount of primary fuel to engine 100. In the case of multiple primary fuel injectors 106, control module 102 may generate and transmit multiple control signals, each control signal having the same or varying pulse widths, to activate multiple primary fuel injectors 106 either simultaneously or sequentially depending on the type of fuel injection system used.

Referring to FIG. 2, there is illustrated a side view of vehicle 10 illustrated in FIG. 1 after being modified according to one embodiment of the present invention. Vehicle 10 may be modified by having a secondary fuel supply system installed for supplying to engine 100 a secondary fuel different from the primary fuel. The secondary fuel supply system may comprise secondary fuel supply module 208 and at least one signal transmitter 204.

In one embodiment, secondary fuel supply module 208 may comprise at least one secondary fuel injector 206, secondary fuel storage component 210, secondary fuel supply line 212, secondary fuel control valve 544 (FIG. 5), and pressure regulator 546 (FIG. 5).

Secondary fuel storage component 210 may be a storage tank configured to store a secondary fuel at a variable storage pressure. Secondary fuel storage component 210 can be installed in the trunk of vehicle 10 using, for example, standard mounts. The stored secondary fuel may be a gaseous fuel such as, for example, propane or natural gas. In one embodiment, the stored secondary fuel can be propane, and the variable storage pressure may vary from between 1.5 and 197 psi, depending on, for example, the temperature of the stored propane.

Secondary fuel control valve 544 may be a solenoid type valve installed on secondary fuel storage component 210, and can be connected to ignition switch 322. When starting engine 100, ignition switch 322 may provide secondary fuel control valve 544 with an activation signal such as, for example, a 12 volt signal that activates secondary fuel control valve 544. In response to being activated, secondary fuel control valve 544 may provide an aperture through which the stored secondary fuel can pass from secondary fuel storage component 210 at the variable storage pressure. When not receiving an activation signal, secondary fuel control valve 544 may be inactivated. When inactivated, secondary fuel control valve 544 may not provide an aperture through which secondary fuel can pass, thus interrupting the supply of secondary fuel from secondary fuel storage component 210.

Pressure regulator 546 may also be installed on secondary fuel storage component 210. Pressure regulator 546 may be installed downstream of secondary fuel control valve 544 such that pressure regulator 546 does not receive any secondary fuel from secondary fuel storage component 210 if secondary fuel control valve 544 is inactivated. If secondary fuel control valve 544 is activated, pressure regulator 546 may receive the secondary fuel from secondary fuel storage component 210 at the variable storage pressure.

Pressure regulator 546 may regulate the pressure of the secondary fuel being supplied from secondary fuel storage component 210 such that pressure regulator 546 can supply the received secondary fuel at a supply pressure at or below the variable storage pressure.

In one embodiment, pressure regulator 546 may be an adjustable pressure regulator configurable to adjust the supply pressure. To adjust the supply pressure, pressure regulator 546 may comprise an adjustable component having a plurality of adjustment settings. Each adjustment setting may correspond to a different maximum pressure at which pressure regulator 546 can supply the secondary fuel from secondary fuel storage component 210. Each maximum pressure can correspond to a supply rate at which the secondary fuel can be supplied from secondary fuel storage component 210. Pressure regulator 546 may be installed at an initial selected adjustment setting corresponding to an initial supply pressure that provides the secondary fuel from secondary fuel storage component 210 at an initial supply rate. For example, if the variable storage pressure is 50 psi, the adjustment setting can be initially set to supply the secondary fuel from secondary fuel storage component 210 at a supply pressure of, for example, 10 psi.

Secondary fuel injector 206 may be a solenoid type fuel injector similar to primary fuel injector 106. Secondary fuel injector 206 may be configured to receive control signals such as, for example, 12 volt signals from control module 102 via a signal transmitter such as signal transmitter 104 or 204. In response to receiving the control signals, secondary fuel injector 206 may become activated. When activated, secondary fuel injector 206 can enter a secondary fuel supply mode in which secondary fuel injector 206 may provide an aperture through which any received fuel may pass. When not receiving the control signals, secondary fuel injector 206 may be inactivated. When inactivated, secondary fuel injector 206 can enter a secondary fuel inactivated mode in which secondary fuel injector 206 may not provide an aperture through which any received fuel can pass, thus interrupting the supply of any received fuel.

In one embodiment, secondary fuel injector 206 may be installed on air intake module 114 such that any fuel supplied by secondary fuel injector 206 is supplied into air intake module 114. For brevity, the description and drawings refer to a single secondary fuel injector 206; however, it will be understood that secondary fuel injector 206 can represent a plurality of secondary fuel injectors 206, all or some of which can be utilized according to embodiments of the present invention.

Referring to FIG. 4, there is illustrated one configuration of engine 100 and air intake module 114 after vehicle 10 has been modified according to an embodiment of the present invention. Air intake module 114 can comprise a throttle body component 428 having air supply control valve 430. Air supply control valve 430 can separate air intake module 114 into upstream portion 432 and downstream portion 434, and may control the amount of air 426 that passes through upstream portion 432 and downstream portion 434, respectively, before being supplied to combustion chamber 438. For brevity, the description and drawings refer to a single combustion chamber 438; however, it will be understood that combustion chamber 438 can represent multiple combustion chambers 438, with air supply control valve 430 controlling the amount of air 426 being supplied to each of multiple combustion chambers 438.

Secondary fuel injector 206 may be installed on air intake module 114 by, for example, tapping a hole in air intake module 114 large enough to insert secondary fuel supply end 207 of secondary fuel injector 206 into air intake module 114. Secondary fuel injector 206 can be secured to air intake module 114 using standard mounts. In one embodiment, secondary fuel injector 206 can be installed in upstream portion 432 of air intake module 114. In a further embodiment, secondary fuel injector 206 can be installed in upstream portion 432 of air intake module 114 and within 3 inches of air supply control valve 430.

Signal transmitter 204 may be an electrical connector for connecting signal transmitter 104 to secondary fuel injector 206. Signal transmitter 204 may be a signal transmitter similar to signal transmitter 104. Signal transmitter 204 may be installed by splicing signal transmitter 204 with signal transmitter 104 such that when control module 102 transmits any generated control signals through signal transmitter 104, the same control signals can be transmitted through signal transmitter 204. Signal transmitter 204 may then be connected to secondary fuel injector 206 such that any control signals generated by control module 102 and transmitted through signal transmitter 204 are received by secondary fuel injector 206.

In response to receiving control signals from control module 102 via signal transmitter 204, secondary fuel injector 206 may become activated for the duration of the pulse width of the generated control signal, providing an aperture through which any fuel received by secondary fuel injector 206 can pass into air intake module 114. It will be understood that in response to control module 102 generating and transmitting a control signal with a pulse width of a duration through signal transmitter 104, both primary fuel injector 106 and secondary fuel injector 206 can become activated for the duration of the pulse width corresponding to the transmitted control signal.

In the case of multiple secondary fuel injectors 206, multiple signal transmitters 204 may be spliced with signal transmitter 104. Each of multiple signal transmitters 204 may be connected to a respective secondary fuel injector 206 of multiple secondary fuel injectors 206. When control module 102 transmits any generated control signals through signal transmitter 104, the same control signals having a pulse width of a duration may also be transmitted to each secondary fuel injector 206 of the multiple secondary fuel injectors 206 via multiple signal transmitters 204.

The electrical characteristics of secondary fuel injector 206 can be similar to those of primary fuel injector 106. Specifically, the millisecond response time of secondary fuel injector 206 can be substantially similar to that of primary fuel injector 106. The impedance of secondary fuel injector 206 can also be substantially similar (for example, within approximately 10% of) the impedance of primary fuel injector 106. More specifically, the impedance of secondary fuel injector 206 can be such that control module 102 can transmit the generated control signals having a pulse width of a duration to secondary fuel injector 206 without malfunctioning from being subjected to additional current when, for example, control signals meant for a high impedance fuel injector are transmitted to a low impedance fuel injector.

Secondary fuel injector 206 may comprise an adjustable component for adjusting the supply rate of fuel supplied by secondary fuel supply module 208 to engine 100. In one embodiment the adjustable component may be an aperture adjustment device. The aperture adjustment device may be a threaded tapered brass rod that can be inserted into the aperture of secondary fuel injector 206, and can be configured to move in and out of secondary fuel injector 206 when rotated. Rotating the brass rod such that it moves in or out of secondary fuel injector 206 can decrease or increase, respectively, the area of the aperture of secondary fuel injector 206. Secondary fuel injector 206 may be installed with the aperture adjustment device at a selected initial adjustment setting that can provide an initial selected supply rate of secondary fuel through secondary fuel injector 206 when secondary fuel injector 206 is activated and receiving secondary fuel.

One end of secondary fuel supply line 212 may be connected to pressure regulator 546 such that when pressure regulator 546 is receiving the secondary fuel from secondary fuel storage component 210, the secondary fuel can be supplied through secondary fuel supply line 212 at the pressure regulated by pressure regulator 546. Secondary fuel supply line 212 can be any supply line suitable for supplying the type of secondary fuel being utilized by the secondary fuel supply system. In an embodiment where the secondary fuel is propane, secondary fuel supply line 212 can be, for example, a UL21 or a CGA-Type 1 propane hose.

The other end of secondary fuel supply line 212 can be connected to secondary fuel injector 206 such that when secondary fuel control valve 544 is activated, the secondary fuel stored in secondary fuel storage component 210 is received by secondary fuel injector 206 through secondary fuel supply line 212, with the secondary fuel being received by the secondary fuel injector 206 at the pressure regulated by pressure regulator 546.

Referring to FIG. 5, there is shown an embodiment of the present invention comprising fuel supply mode selection component 540. In one embodiment, fuel supply mode selection component 540 comprises a toggle switch that can switch between a primary fuel mode and a secondary fuel mode of vehicle 10. When the toggle switch is set to the primary fuel mode, primary fuel supply module 108 can be configured to supply primary fuel from primary fuel storage component 110 to primary fuel injector 106, and secondary fuel supply module 208 can be configured to interrupt supply of the secondary fuel from secondary fuel storage component 210 to secondary fuel injector 206. When the toggle switch is set to the secondary fuel mode, secondary fuel supply module 208 can be configured to supply the secondary fuel from secondary fuel storage component 210 to secondary fuel injector 206, and primary fuel supply module 108 can be configured to interrupt supply of the primary fuel from the primary fuel storage component 110 to primary fuel injector 106.

In one embodiment, the toggle switch can receive power from ignition switch 322. In response to the toggle switch being set to the primary fuel mode, ignition switch 322 can be configured to provide an activation signal such as, for example, a 12 volt signal to activate a fuel pump relay, whereas secondary fuel control valve 544 may receive no activation signal. In response to being activated, fuel pump relay can complete a power supply circuit of primary fuel pump 542, thereby powering primary fuel pump 542 such that primary fuel pump 542 may supply the primary fuel from primary fuel storage component 110 to primary fuel injector 106.

In response to the toggle switch being set to the secondary fuel mode, ignition switch 322 can be configured to provide an activation signal such as, for example, a 12 volt signal to secondary fuel control valve 544, whereas the fuel pump relay may receive no activation signal. When not receiving an activation signal, the fuel pump relay may cause the power supply circuit of primary fuel pump 542 to be incomplete, resulting in primary fuel pump 542 not receiving power. When not receiving power, primary fuel pump 542 may be unable to supply the primary fuel through primary fuel supply line 112 to primary fuel injector 106.

When in the secondary fuel mode, the secondary fuel supply system of modified vehicle 10 may operate as follows:

In response to ignition switch 322 starting engine 100, ignition switch 322 can provide an activation signal such as, for example, a 12 volt signal to secondary fuel control valve 544. In response to receiving the activation signal from ignition switch 322, secondary fuel control valve 544 may become activated. When activated, secondary fuel control valve 544 may allow the secondary fuel to pass from secondary fuel storage component 210 at the variable storage pressure to pressure regulator 546.

Pressure regulator 546 can regulate the pressure of the secondary fuel received from secondary fuel storage component 210 based on an adjustment setting at which pressure regulator 546 can be set. Adjusting the supply pressure of the secondary fuel via pressure regulator 546 can result in pressure regulator 546 supplying the secondary fuel to secondary fuel supply line 212 at a supply pressure at or below the variable storage pressure. After being supplied to the secondary fuel supply line 212 at the supply pressure, the secondary fuel may pass through secondary fuel supply line 212 and can be received by secondary fuel injector 206.

Further in response to ignition switch 322 starting engine 100, control module 102 may generate a control signal having a pulse width of a duration, and may transmit the control signal through both signal transmitter 104 and signal transmitter 204. The control signal can be received by both primary fuel injector 106 and secondary fuel injector 206. When vehicle 10 is in the secondary fuel mode, however, primary fuel pump 542 may be inactivated, resulting in no primary fuel being received by primary fuel injector 106, and therefore, no primary fuel being supplied to engine 100.

The control signal received by secondary fuel injector 206 via signal transmitter 204 may activate secondary fuel injector 206. Activating secondary fuel injector 206 can cause secondary fuel injector 206 to provide an aperture through which the received secondary fuel may pass into upstream portion 432 of air intake module 114. The amount of secondary fuel that passes into upstream portion 432 of air intake module 114 can depend on the duration of the pulse width of the generated control signal and the supply rate of the secondary fuel. The supply rate of the secondary fuel can depend on the supply pressure of the secondary fuel as regulated by pressure regulator 546, the area of the aperture of secondary fuel injector 206, and the number of secondary fuel injectors 206 in the case that multiple secondary fuel injectors 206 are being utilized.

The amount of secondary fuel that passes into air intake module 114 can mix with supplied air 426 as air 426 passes through upstream portion 432 of air intake module 114, past air supply control valve 430 of throttle body component 428, through downstream portion 434 of air intake module 114, and into intake manifold 436 of engine 100. When intake valve 437 of combustion chamber 438 is open, the secondary fuel and air mixture can enter combustion chamber 438 for combustion.

The installed secondary fuel supply system of modified vehicle 10 may require calibration to account for engine 100 utilizing a secondary fuel that may have different properties than the primary fuel. For example, the duration of the pulse width of the control signals generated by control module 102 may be generated based on an amount of primary fuel to be supplied to engine 100 to satisfy the fuel demand of engine 100. However, the secondary fuel may have, for example, a different caloric value than the primary fuel, which may result in the amount of the secondary fuel to be supplied to engine 100 within the duration of each pulse width to satisfy the fuel demand of engine 100 being different than the amount of primary fuel to be supplied to engine 100 within the duration of each pulse width to satisfy the fuel demand of engine 100. Accordingly, to satisfy the fuel demand of engine 100, the supply rate of the secondary fuel may have to be adjusted to provide a greater or lesser amount of secondary fuel to engine 100 within the duration of each pulse width of the control signals generated by control module 102 and received by secondary fuel injector 206.

Calibrating the installed secondary fuel supply system of modified vehicle 10 may comprise the following:

It can first be determined whether the initial secondary fuel supply rate at which secondary fuel supply module 208 is supplying initial amounts of the secondary fuel to engine 100 is a selected secondary fuel supply rate. The selected secondary fuel supply rate can be a supply rate of secondary fuel that is sufficient to provide, within the duration of the pulse width of the control signals generated by control module 102, to engine 100 an amount of the secondary fuel that can satisfy the fuel demand of engine 100. In one embodiment, determining the air to secondary fuel ratio of the mixture being supplied to engine 100 of air 426 and secondary fuel may determine whether the initial supply rate of the secondary fuel is the selected secondary fuel supply rate.

In one embodiment, the air to secondary fuel ratio of the mixture being supplied to engine 100 of air 426 and secondary fuel can be determined using a generic vehicle gas analyzer device; for example, a gas analyzer such as Snapon Tool HHGA4X, EMS model 5002, or AEM 30-4900 can be used. A sensor component of the analyzer device can be inserted into an exhaust stream of engine 100. Engine 100 can then be put under a load; for example, vehicle 10 can be operated on a dynamometer, or can be driven. While engine 100 is operating under a load, the sensor component of the analyzer device can provide the analyzer device with information about the composition of exhaust gases of engine 100, including the air to secondary fuel ratio of the mixture being supplied to engine 100 of air 426 and secondary fuel. The analyzer can output this information to a user.

The determined air to secondary fuel ratio can then be compared to an optimal air to secondary fuel ratio. The optimal air to secondary fuel ratio may vary depending on the type of secondary fuel being utilized by engine 100, the load experienced by engine 100, and the general characteristics of engine 100. For example, when engine 100 is subject to a light load, such as when engine 100 is idling, the optimal air to secondary fuel ratio may be a stoichiometric ratio of air 426 to secondary fuel. The stoichiometric ratio of air to propane and air to natural gas is approximately 15.5:1 and 17.2:1, respectively, while the stoichiometric ratio of air to gasoline is approximately 14.7:1. When engine 100 is subject to a heavy load, such as when vehicle 10 is rapidly accelerating, the optimal air to secondary fuel ratio may be a ratio of air 426 to secondary fuel that is less than the stoichiometric ratio of air 426 to secondary fuel. The optimal air to secondary fuel ratio may be determined by utilizing software programs or reference charts designed for such a purpose.

It can then be determined by what amount the initial supply rate of the secondary fuel must be adjusted to supply the secondary fuel to engine 100 at the selected secondary fuel supply rate such that the air to secondary fuel ratio of the mixture being supplied to engine 100 of air 426 and secondary fuel is the optimal air to secondary fuel ratio; the amount the initial supply rate must be adjusted can be determined by, for example, utilizing software programs or reference charts designed for such a purpose. If it is determined that the initial supply rate is the selected secondary fuel supply rate, then no calibration may be required.

If, however, it is determined that the initial secondary fuel supply rate is not the selected secondary fuel supply rate, then calibration may be required. Calibrating the secondary fuel supply system may comprise configuring secondary fuel supply module 208 to adjust the secondary fuel supply rate at which the secondary fuel is supplied to engine 100. The supply rate of the secondary fuel can be adjusted based on the amount determined in the previous step. In one embodiment, the supply rate of the secondary fuel can be adjusted by, for example, setting pressure regulator 546 to a selected adjustment setting that corresponds to a supply pressure of secondary fuel that can provide the selected secondary fuel supply rate of the secondary fuel. In another embodiment, the supply rate of the secondary fuel can be adjusted by, for example, adjusting the aperture adjustment device of secondary fuel injector 206 to increase or decrease the area of the aperture of secondary fuel injector 206 such that secondary fuel injector 206 supplies the secondary fuel at the selected secondary fuel supply rate. In a further embodiment, the supply rate of the secondary fuel can be adjusted by, for example, replacing the installed secondary fuel injector 206 with a different secondary fuel injector 206 comprising an aperture area that is smaller or larger than the aperture area of the replaced secondary fuel injector 206 such that the different secondary fuel injector 206 supplies the secondary fuel at the selected secondary fuel supply rate. In yet a further embodiment, the supply rate of the secondary fuel can be adjusted by, for example, installing additional secondary fuel injectors 206, and configuring each additional secondary fuel injector 206 to simultaneously operate according to the embodiments of the present invention such that the multiple secondary fuel injectors 206 supply the secondary fuel at the selected secondary fuel supply rate.

In embodiments where secondary fuel storage component 210 is limited to supplying the secondary fuel within a specific range of pressures, or where pressure regulator 546 is limited to regulating the supply pressure within a specific range of pressures, it may be desirable to adjust the supply rate of the secondary fuel by adjusting or configuring one or more components of secondary fuel supply module 208.

In one embodiment, the supply rate of the secondary fuel may be adjusted by adjusting pressure regulator 546 while also adjusting the aperture area of secondary fuel injector 206. Adjusting the supply rate of the secondary fuel in such a manner may be desirable where the minimum pressure of the specific range of pressures nonetheless results in too much secondary fuel being supplied into air intake module 114 within each pulse width. In such a case, the aperture adjustment device may be adjusted to decrease the size of the aperture of secondary fuel injector 206, thereby further decreasing the amount of secondary fuel supplied into air intake module 114 within each pulse width.

In a different embodiment, the supply rate of the secondary fuel may be adjusted by adjusting pressure regulator 546 and replacing the installed secondary fuel injector 206 with a different secondary fuel injector 206 comprising an aperture of an area different than the area of the aperture of the installed secondary fuel injector 206. In such an embodiment, the different secondary fuel injector 206 may be installed to increase or decrease the size of the aperture area through which the secondary fuel can be supplied at the supply pressure, thereby increasing or decreasing the amount of secondary fuel supplied into air intake module 114 within each pulse width. Adjusting the supply rate of the secondary fuel in such a manner may be desirable where the minimum or maximum pressure of the specific range of pressures nonetheless results in too much or not enough, respectively, secondary fuel being supplied into air intake module 114 within each pulse width.

In a further embodiment, the different secondary fuel injector 206 may comprise an aperture adjustment device configured to adjust the aperture area of a different size within an aperture area adjustment range different than the aperture area adjustment range of the installed secondary fuel injector 206. For example, the installed secondary fuel injector 206 may have an aperture area adjustment range that can be adjusted to provide the secondary fuel at a supply rate between 5 and 6 cubic feet per minute, whereas the different secondary fuel injector 206 may have an aperture area adjustment range that can be adjusted to provide the secondary fuel at a supply rate between 6 and 7 cubic feet per minute. In a different example, the different secondary fuel injector 206 may have an aperture area adjustment range that can be adjusted to provide the secondary fuel at a supply rate between 4 and 5 cubic feet per minute.

In yet a further embodiment, the supply rate of the secondary fuel may be adjusted by adjusting pressure regulator 546 and installing additional secondary fuel injectors 206. Adjusting the supply rate in such a manner may be desirable where the maximum pressure of the specific range of pressures nonetheless results in not enough secondary fuel being supplied into air intake module 114 within each pulse width. In such an embodiment, the additional secondary fuel injectors 206 may be installed and configured according to the embodiments of the present invention, thereby further increasing the amount of secondary fuel supplied into air intake module 114 within each pulse width.

It will be understood that the supply rate may be adjusted using a combination of the above embodiments. For example, the installed secondary fuel injector 206 may be replaced with a different secondary fuel injector 206 in addition to having additional secondary fuel injectors 206 installed according to embodiments of the present invention, where the aperture area of each secondary fuel injector 206 may then be adjusted using aperture adjustment devices corresponding to each secondary fuel injector 206.

In one embodiment, instead of determining by what amount the supply rate of the secondary fuel must be adjusted to supply the secondary fuel to engine 100 at the selected secondary fuel supply rate, the step of determining the air to secondary fuel ratio of the mixture being supplied to engine 100 of air 426 and secondary fuel, and the step of comparing the determined air to secondary fuel ratio to an optimal air to secondary fuel ratio can be repeated while experimentally varying the settings of the adjustment components, or by adding or replacing secondary fuel injectors 206, until the gas analyzer device determines that the air to secondary fuel ratio of the mixture being supplied to engine 100 of air 426 and secondary fuel is at or close to the optimal air to secondary fuel ratio. For example, the adjustment settings of the aperture adjustment device of secondary fuel injector 206 or pressure regulator 546 can be experimentally varied until the aperture area of secondary fuel injector 206 or the supply pressure of the secondary fuel being supplied to secondary fuel injector 206 provide the selected secondary fuel supply rate, resulting in the gas analyzer device outputting an optimal air to secondary fuel ratio reading to the user, or an air to secondary fuel ratio reading that is, say, within 2% or 5% of the optimal air to secondary fuel ratio.

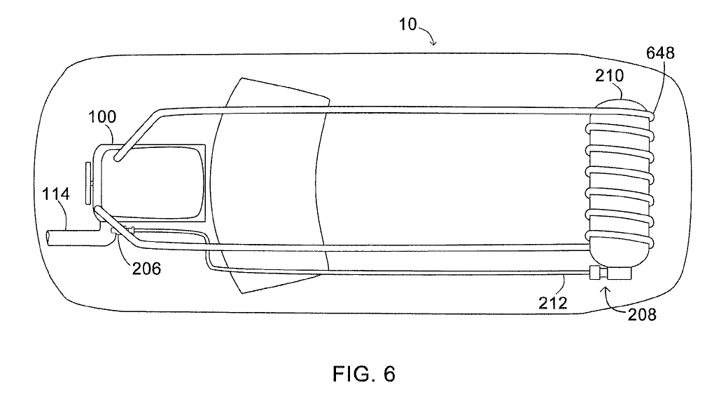

Referring to FIG. 6, there is illustrated one embodiment of the secondary fuel supply system of modified vehicle 10 comprising heating component 648. Heating component 648 may be installed on secondary fuel storage component 210. A low ambient temperature may result in the pressure of the secondary fuel stored in secondary fuel storage component 210 falling below a suitable variable storage pressure. In such a situation, heating component 648 may be configured to transfer heat energy to the stored secondary fuel to maintain the variable storage pressure above a suitable storage pressure. A suitable storage pressure may be defined as a pressure at or above the pressure setting corresponding to the pressure at which pressure regulator 546 is set to supply the secondary fuel to secondary fuel supply line 212. In an embodiment where the secondary fuel stored in secondary fuel storage component 210 is propane, a suitable storage pressure may be, for example, a variable storage pressure above 5.5 psi, corresponding to a temperature above approximately −30° F. of a liquefied portion of the stored propane.

As illustrated in FIG. 6, in one embodiment heating component 648 may be, for example, a hose connected to the engine coolant system of engine 100. The hose may be connected to the engine coolant system such that the hose circulates the engine coolant used to cool engine 100. After engine 100 has been operating for a period of time, engine 100 may heat the engine coolant circulating throughout the hose to a temperature sufficient to heat secondary fuel storage component 210. The hose may be wrapped around secondary fuel storage component 210 to cover a surface area of secondary fuel storage component 210. The covered surface area may be an area large enough to enable the hose to transfer a sufficient amount of heat energy to the stored secondary fuel to raise the variable storage pressure to a suitable storage pressure.

When engine 100 is to be started in low ambient temperatures, initially operating modified vehicle 10 in the primary fuel mode can allow engine 100 to raise the temperature of the engine coolant circulating through the hose to a temperature sufficient to heat secondary fuel storage component 210; this may in turn raise the variable storage pressure to a pressure above the suitable storage pressure. When the variable storage pressure reaches a suitable storage pressure, fuel supply mode selection component 540 may be used to switch vehicle 10 to operate in the secondary fuel mode.

In a further embodiment of the present invention, control module 102 may be configured to receive sensor signals from sensors configured to determine the amount of primary fuel in primary fuel storage component 110 and the amount of secondary fuel in secondary fuel storage component 210. Control module 102 can be further configured to automatically have fuel supply mode selection component 540 switch to the primary fuel mode if vehicle 10 is in the secondary fuel supply mode and a low amount of secondary fuel in secondary fuel storage component 210 is detected, or automatically switch to the secondary fuel supply mode if vehicle 10 is in the primary fuel supply mode and a low amount of primary fuel in primary fuel storage component 110 is detected.

In yet a further embodiment, modified vehicle 10 may comprise various safety mechanisms. In one embodiment, secondary fuel control valve 544 may act as a secondary fuel safety valve that can interrupt the supply of secondary fuel from secondary fuel storage component 210 when control module 102 determines that modified vehicle 10 does not satisfy a safety parameter. For example, in response to determining that vehicle 10 does not satisfy a safety parameter, control module 102 may be configured to interrupt any activation signals being sent to secondary fuel control valve 544 such that secondary fuel control valve 544 may become inactivated, thereby interrupting supply of secondary fuel from secondary fuel storage component 210.

In one embodiment, control module 102 may be configured to receive information corresponding to safety parameters of vehicle 10 from a plurality of safety sensors via safety sensor signals. Typical safety sensors and corresponding safety parameters may comprise an ignition switch sensor for sensing whether vehicle 10 is in operation; a vehicle speed sensor for sensing whether vehicle 10 is in motion; an electrical system diagnostic sensor for sensing a malfunction in an electrical system of vehicle 10, such as a failure of one of plurality of sensors 316, or a short-out of secondary fuel injector 206 or primary fuel injector 106; or an accelerometer for sensing whether vehicle 10 has been in an accident.

Control module 102 may be configured to use the information provided by the safety sensor signals to determine whether vehicle 10 satisfies the safety parameters. Accordingly, the safety sensors may further comprise any sensors that may provide safety sensor signals comprising information related to determining safety parameters of vehicle 10.

In response to determining that vehicle 10 satisfies the safety parameters, control module 102 may generate a derivative safety signal, for example, a 12 volt signal, and may transmit the derivative safety signal to a safety component via a safety signal transmitter. In one embodiment, the safety component can be a safety relay switch configured such that in response to receiving the derivative safety signal, the safety relay switch can enter a secondary fuel safe mode in which safety relay switch can complete a circuit configured to provide activation signals to secondary fuel control valve 544. Such a configuration may allow secondary fuel control valve 544 to supply secondary fuel from secondary fuel storage component 210 in response to receiving an activation signal from, for example, ignition switch 322.

In response to determining that vehicle 10 does not satisfy a safety parameter, control module 102 may cease transmitting the derivative safety signal to the safety relay switch. When not receiving the derivative safety signal, the safety relay switch can enter a secondary fuel failsafe mode in which safety relay switch can interrupt the circuit configured to provide activation signals to secondary fuel control valve 544. Interrupting the circuit configured to provide activation signals to secondary fuel control valve 544 can prevent secondary fuel control valve 544 from receiving any activation signals from, for example, ignition switch 322. When not receiving any activation signals, secondary fuel control valve 544 may become inactivated, interrupting the supply of secondary fuel from secondary fuel storage component 210.

In another embodiment, secondary fuel supply module 208, signal transmitter 204 and fuel supply mode selection component 540 may be installed in vehicle 10 as original equipment. In one embodiment, secondary fuel supply module 208, signal transmitter 204 and fuel supply mode selection component 540 may be installed in vehicle 10 while vehicle 10 is being manufactured.

In a different embodiment, only a subset of secondary fuel supply module 208, signal transmitter 204 and fuel supply mode selection component 540 may be installed in vehicle 10 as original equipment to, for example, help streamline future conversion of vehicle 10 to utilize a secondary fuel. In one embodiment, only secondary fuel storage component 210 may not be installed as original equipment, leaving it to an end user to purchase and install a secondary fuel storage component 210 should they want to take advantage of the other components installed during manufacture in vehicle 10. In another embodiment, only secondary fuel injector 206 may be installed in vehicle 10 as original equipment.

In a further embodiment, secondary fuel injector 206 may be installed into throttle body component 428 of vehicle 10 as original equipment. For example, secondary fuel injector 206 may be installed into throttle body component 428 of vehicle 10 while vehicle 10 is being manufactured. In a different embodiment, secondary fuel injector 206 may be part of an after-market throttle body component that can replace a throttle body component similar to throttle body component 428 of vehicle 10.

Other variations and modifications of the invention are possible. All such modifications and variations are believed to be within the sphere and scope of the invention as defined by the claims appended hereto.

1. A method for modifying a vehicle to receive and utilize a secondary fuel, the vehicle prior to modification comprising
i) an internal combustion engine configured to receive and utilize a primary fuel;
ii) a primary fuel supply module for supplying the primary fuel to the engine, the primary fuel supply module comprising a primary fuel injector having a primary fuel supply mode for supplying the primary fuel to the engine, and a primary fuel inactivated mode for interrupting supply of the primary fuel to the engine;
iii) a plurality of sensors for providing sensor signals for determining engine parameters representing an engine fuel demand, the plurality of sensors being configured to change the sensor signals provided in response to changes in the engine parameters; and
iv) a control module configured to receive the sensor signals and generate, based on the sensor signals, a signal having a pulse width with a duration, the control module being further operable to change the duration of the pulse width based on changes in the sensor signals,
the control module having a signal transmitter configured for transmitting the signal to the primary fuel injector to maintain the primary fuel injector in the primary fuel supply mode when receiving the signal for the duration of the pulse width to supply an amount of primary fuel to the engine sufficient to satisfy the engine fuel demand, the primary fuel injector being configured to return to the primary fuel inactivated mode when not receiving the signal;
the method comprising:
a) installing in the vehicle a secondary fuel supply module for supplying to the engine a secondary fuel different from the primary fuel, the secondary fuel supply module comprising a secondary fuel injector having a secondary fuel supply mode for supplying the secondary fuel to the engine, and a secondary fuel inactivated mode for interrupting supply of the secondary fuel to the engine,
wherein the secondary fuel supply module is configurable to adjust a secondary fuel supply rate at which the secondary fuel is supplied to the engine, and
wherein the engine fuel demand corresponds to an amount of the secondary fuel to be supplied to the engine to satisfy the engine fuel demand, the amount of the secondary fuel to be supplied to the engine to satisfy the engine fuel demand being different from the amount of the primary fuel to be supplied to the engine to satisfy the engine fuel demand;
b) connecting the signal transmitter to the secondary fuel injector such that the signal transmitter is configured to transmit the signal having the pulse width with the duration to the secondary fuel injector to maintain the secondary fuel injector in the secondary fuel supply mode when receiving the signal for the duration of the pulse width, the secondary fuel injector being configured to return to the secondary fuel inactivated mode when not receiving the signal; and
c) installing the secondary fuel supply module at a selected adjustment setting to provide a selected secondary fuel supply rate such that when the signal is received by the secondary fuel injector for the duration of the pulse width, the secondary fuel injector is maintained in the secondary fuel supply mode to supply to the engine the amount of the secondary fuel to be supplied to the engine to satisfy the engine fuel demand,
wherein when the secondary fuel is being supplied at the selected secondary fuel supply rate the secondary fuel injector is configured to change the amount of the secondary fuel provided to the engine in response to changes in the duration of the pulse width of the signal received.

2. The method of claim 1, wherein step c) further comprises the steps of
i) installing the secondary fuel supply module at an initial adjustment setting to provide an initial secondary fuel supply rate such that when the signal is received by the secondary fuel injector for the duration of the pulse width, the secondary fuel injector is maintained in the secondary fuel supply mode to provide to the engine an initial amount of the secondary fuel;
ii) determining if the initial amount of the secondary fuel is the amount of the secondary fuel to be supplied to the engine to satisfy the engine fuel demand; and
iii) if the initial amount of the secondary fuel is the amount of the secondary fuel to be supplied to the engine to satisfy the engine fuel demand, then
leaving the secondary fuel supply module at the initial adjustment setting, otherwise
adjusting the secondary fuel supply module to the selected adjustment setting to provide the selected secondary fuel supply rate.

3. The method of claim 1, wherein the primary fuel is gasoline.

4. The method of claim 1, wherein the secondary fuel is one of propane and natural gas.

5. The method of claim 1, wherein the vehicle prior to modification further comprises an air intake module for supplying air at an air pressure to the engine, the air pressure being at or above barometric pressure,
wherein the secondary fuel supply module is configured to supply at a supply pressure the secondary fuel to the secondary fuel injector and to store the secondary fuel at a variable storage pressure, the variable storage pressure being at or above the supply pressure, the supply pressure being above the air pressure,
wherein the secondary fuel supply module further comprises an adjustable pressure regulator configurable to adjust the supply pressure, and
wherein installing the secondary fuel supply module at the selected adjustment setting comprises adjusting the adjustable pressure regulator such that the adjustable pressure regulator provides the secondary fuel at the selected secondary fuel supply rate and at the supply pressure when the secondary fuel injector is supplying the secondary fuel to the engine.

6. The method of claim 1, wherein when in the secondary fuel supply mode the secondary fuel injector is configured to supply to the engine the secondary fuel through an aperture, and wherein the secondary fuel injector comprises an adjustable aperture device for adjusting an area of the aperture.

7. The method of claim 1, the method further comprising the step of installing a fuel supply mode selection component for selecting for the vehicle either a primary fuel mode or a secondary fuel mode,
wherein
when the primary fuel mode is selected, the primary fuel supply module is configured to supply the primary fuel to the primary fuel injector and the secondary fuel supply module is configured to interrupt supply of the secondary fuel to the secondary fuel injector, and
when the secondary fuel mode is selected, the secondary fuel supply module is configured to supply the secondary fuel to the secondary fuel injector and the primary fuel supply module is configured to interrupt supply of the primary fuel to the primary fuel injector.

8. The method of claim 1, wherein the vehicle prior to modification further comprises an air intake module for supplying air to the engine, the air intake module comprising a throttle body component having an air supply control valve for controlling the supply of air to the engine and for separating the air intake module into an upstream portion and a downstream portion, the air intake module being configured such that when the air intake module is supplying the air to the engine the air flows through the upstream portion of the air intake module, through the air supply control valve, and through the downstream portion of the air intake module, respectively, before being supplied to the engine, and
wherein the secondary fuel injector is installed in the vehicle such that when the secondary fuel injector supplies the secondary fuel from the secondary fuel supply module and the air intake module is supplying air to the engine, the secondary fuel injector supplies the secondary fuel from the secondary fuel supply module into the upstream portion of the air intake module such that the supplied secondary fuel mixes with the air flowing through the air intake module forming a secondary fuel and air mixture to be supplied to the engine.

9. The method of claim 8, wherein the secondary fuel injector is installed within 3 inches of the air supply control valve.

10. The method of claim 1, wherein the secondary fuel supply module comprises a secondary fuel storage component configured to store at a variable storage pressure a stored amount of the secondary fuel, and a heating component for transferring heat energy from the heating component to the stored amount of the secondary fuel to raise the variable storage pressure to a suitable storage pressure.

11. The method of claim 1, wherein the secondary fuel supply module comprises a safety component having a secondary fuel safe mode for supplying the secondary fuel to the secondary fuel injector, and a secondary fuel failsafe mode for interrupting supply of the secondary fuel to the secondary fuel injector,
wherein the vehicle prior to modification further comprises at least one safety sensor for providing a safety signal representing vehicle safety parameters corresponding to at least one of the vehicle being in operation, the vehicle being in an accident, and the vehicle malfunctioning, and
wherein the control module is further configured to receive the at least one safety signal and generate, based on the at least one safety signal, a derivative safety signal representing whether the vehicle satisfies the vehicle safety parameters, the control module having a safety signal transmitter configured for transmitting the derivative safety signal;
the method further comprising connecting the safety signal transmitter to the safety component such that the safety signal transmitter is configured to transmit the derivative safety signal to the safety component to maintain the safety component in the secondary fuel safe mode when receiving the derivative safety signal, the safety component being configured to return to the secondary fuel failsafe mode when not receiving the derivative safety signal.

12. The method of claim 1, wherein the method is carried out during manufacture of the vehicle.

13. The method of claim 1, wherein the engine parameters comprise position of an air intake throttle, temperature of air supplied to the engine, temperature of engine coolant, rotational speed of the engine, barometric pressure, and at least one of pressure in an intake manifold of the engine and mass flow rate of air supplied to the engine.

14. The method of claim 13, wherein the engine parameters further comprise oxygen concentration of engine exhaust gases.

15. A vehicle modified to receive and utilize a secondary fuel, the vehicle comprising:
i) an internal combustion engine configured to receive and utilize a primary fuel;
ii) a primary fuel supply module for supplying the primary fuel to the engine, the primary fuel supply module comprising a primary fuel injector having a primary fuel supply mode for supplying the primary fuel to the engine, and a primary fuel inactivated mode for interrupting supply of the primary fuel to the engine;
iii) a plurality of sensors for providing sensor signals for determining engine parameters representing an engine fuel demand, the plurality of sensors being configured to change the sensor signals provided in response to changes in the engine parameters;
iv) a control module configured to receive the sensor signals and generate, based on the sensor signals, a signal having a pulse width with a duration, the control module being further operable to change the duration of the pulse width based on changes in the sensor signals,
the control module having a signal transmitter configured for transmitting the signal to the primary fuel injector to maintain the primary fuel injector in the primary fuel supply mode when receiving the signal for the duration of the pulse width to supply an amount of primary fuel to the engine sufficient to satisfy the engine fuel demand, the primary fuel injector being configured to return to the primary fuel inactivated mode when not receiving the signal; and
v) a secondary fuel supply module for supplying to the engine a secondary fuel different from the primary fuel, the secondary fuel supply module comprising a secondary fuel injector having a secondary fuel supply mode for supplying the secondary fuel to the engine, and a secondary fuel inactivated mode for interrupting supply of the secondary fuel to the engine,
wherein the secondary fuel supply module is configurable to adjust a secondary fuel supply rate at which the secondary fuel is supplied to the engine,
wherein the engine fuel demand corresponds to an amount of the secondary fuel to be supplied to the engine to satisfy the engine fuel demand, the amount of the secondary fuel to be supplied to the engine to satisfy the engine fuel demand being different from the amount of the primary fuel to be supplied to the engine to satisfy the engine fuel demand,
wherein the signal transmitter is connected to the secondary fuel injector such that the signal transmitter is configured to transmit the signal having the pulse width with the duration to the secondary fuel injector to maintain the secondary fuel injector in the secondary fuel supply mode when receiving the signal for the duration of the pulse width, the secondary fuel injector being configured to return to the secondary fuel inactivated mode when not receiving the signal,
wherein the secondary fuel supply module is at a selected adjustment setting to provide a selected secondary fuel supply rate such that when the signal is received by the secondary fuel injector for the duration of the pulse width, the secondary fuel injector is maintained in the secondary fuel supply mode to supply to the engine the amount of the secondary fuel to be supplied to the engine to satisfy the engine fuel demand, and
wherein when the secondary fuel is being supplied at the selected secondary fuel supply rate the secondary fuel injector is configured to change the amount of the secondary fuel provided to the engine in response to changes in the duration of the pulse width of the signal received.

16. The vehicle of claim 15, wherein the primary fuel is gasoline.

17. The vehicle of claim 15, wherein the secondary fuel is one of propane and natural gas.

18. The vehicle of claim 15, the vehicle further comprising an air intake module for supplying air at an air pressure to the engine, the air pressure being at or above barometric pressure,
wherein the secondary fuel supply module is configured to supply at a supply pressure the secondary fuel to the secondary fuel injector and to store the secondary fuel at a variable storage pressure, the variable storage pressure being at or above the supply pressure, the supply pressure being above the air pressure,
wherein the secondary fuel supply module further comprises an adjustable pressure regulator configurable to adjust the supply pressure, and
wherein the pressure regulator is configured to provide the secondary fuel at the selected secondary fuel supply rate and at the supply pressure when the secondary fuel injector is supplying the secondary fuel to the engine.

19. The vehicle of claim 15, wherein when in the secondary fuel supply mode the secondary fuel injector is configured to supply to the engine the secondary fuel through an aperture, and wherein the secondary fuel injector comprises an adjustable aperture device for adjusting an area of the aperture.

20. The vehicle of claim 15, the vehicle further comprising a fuel supply mode selection component for selecting for the vehicle either a primary fuel mode or a secondary fuel mode,
wherein
when the primary fuel mode is selected, the primary fuel supply module is configured to supply the primary fuel to the primary fuel injector and the secondary fuel supply module is configured to interrupt supply of the secondary fuel to the secondary fuel injector, and
when the secondary fuel mode is selected, the secondary fuel supply module is configured to supply the secondary fuel to the secondary fuel injector and the primary fuel supply module is configured to interrupt supply of the primary fuel to the primary fuel injector.

21. The vehicle of claim 15, the vehicle further comprising an air intake module for supplying air to the engine, the air intake module comprising a throttle body component having an air supply control valve for controlling the supply of air to the engine and for separating the air intake module into an upstream portion and a downstream portion, the air intake module being configured such that when the air intake module is supplying the air to the engine the air flows through the upstream portion of the air intake module, through the air supply control valve, and through the downstream portion of the air intake module, respectively, before being supplied to the engine, and
wherein the secondary fuel injector is configured such that when the secondary fuel injector supplies the secondary fuel from the secondary fuel supply module and the air intake module is supplying air to the engine, the secondary fuel injector supplies the secondary fuel from the secondary fuel supply module into the upstream portion of the air intake module such that the supplied secondary fuel mixes with the air flowing through the air intake module forming a secondary fuel and air mixture to be supplied to the engine.

22. The vehicle of claim 21, wherein the secondary fuel injector is configured to supply the secondary fuel within 3 inches of the air supply control valve.

23. The vehicle of claim 15, wherein the secondary fuel supply module comprises a secondary fuel storage component configured to store at a variable storage pressure a stored amount of the secondary fuel, and a heating component for transferring heat energy from the heating component to the stored amount of the secondary fuel to raise the variable storage pressure to a suitable storage pressure.

24. The vehicle of claim 15, wherein the secondary fuel supply module comprises a safety component having a secondary fuel safe mode for supplying the secondary fuel to the secondary fuel injector, and a secondary fuel failsafe mode for interrupting supply of the secondary fuel to the secondary fuel injector,
the vehicle further comprising at least one safety sensor for providing a safety signal representing vehicle safety parameters corresponding to at least one of the vehicle being in operation, the vehicle being in an accident, and the vehicle malfunctioning, and
wherein the control module is further configured to receive the at least one safety signal and generate, based on the at least one safety signal, a derivative safety signal representing whether the vehicle satisfies the vehicle safety parameters, the control module having a safety signal transmitter configured for transmitting the derivative safety signal; and
wherein the safety signal transmitter is configured to transmit the derivative safety signal to the safety component to maintain the safety component in the secondary fuel safe mode when receiving the derivative safety signal, the safety component being configured to return to the secondary fuel failsafe mode when not receiving the derivative safety signal.

25. The vehicle of claim 15, wherein the engine parameters comprise position of an air intake throttle, temperature of air supplied to the engine, temperature of engine coolant, rotational speed of the engine, barometric pressure, and at least one of pressure in an intake manifold of the engine and mass flow rate of air supplied to the engine.

26. The vehicle of claim 25, wherein the engine parameters further comprise oxygen concentration of engine exhaust gases.
